(19) United States
(12) Patent Application Publication
(10) Pub. No.: US 2024/0005650 A1
(43) Pub. Date: Jan. 4, 2024

(54) REPRESENTATION LEARNING

(71) Applicant: Bayer Aktiengesellschaft, Leverkusen (DE)

(72) Inventors: Jonas DIPPEL, Berlin (DE); Steffen VOGLER, Berlin (DE); Johannes HÖHNE, Oranienburg (DE)

(73) Assignee: Bayer Aktiengesellschaft, Leverkusen (DE)

(21) Appl. No.: 18/038,182

(22) PCT Filed: Nov. 12, 2021
(86) PCT No.: PCT/EP2021/081449

§ 371 Date: May 22, 2023

(30) Foreign Application Priority Data
Nov. 20, 2020 (EP) 20208926.4
Mar. 11, 2023 (EP) 21162000.0

(51) Int. Cl. G06V 10/82; G06V 10/774; G06V 10/75

(52) U.S. Cl. CPC G06V 10/82; G06V 10/7753; G06V 10/751

(57) ABSTRACT

Systems, methods, and computer programs disclosed herein relate to training of machine learning models on the basis of image training data with a limited number of labeled images.

### CROSS REFERENCE TO RELATED APPLICATIONS

This application is a national stage application under 35 U.S.C. § 371 of International Application No. PCT/EP2021/081449, filed internationally on Nov. 12, 2021, which claims the benefit of European Application No. 20208926.4, filed Nov. 20, 2020 and 21162000.0, filed on Mar. 11, 2021.

### FIELD

Systems, methods, and computer programs disclosed herein relate to training of machine learning models on the basis of image training data with a limited number of labeled images.

### BACKGROUND

Machine learning models receive an input and generate an output, e.g., a predicted output, based on the received input and on values of the parameters of the model.

Machine learning models play an increasingly important role in many applications, particularly medical applications.

For example, machine learning models can be used to suggest to a healthcare professional whether one or more medical images of a patient are likely to have one or more given characteristics so that the healthcare professional can diagnose a medical condition of the patient.

In order for a machine learning model to perform this function, the machine learning model needs to be trained using annotated (labeled) medical training images that indicate whether the training images have one or more of the characteristics. For example, for the machine learning model to be able to spot a condition in an image, training images annotated as showing the condition and training images annotated as not showing the condition can be used to train the machine learning model.

However, successful use of machine learning models for this purpose is impeded by the lack of large annotated (labeled) datasets in medical imaging. Annotating (labeling) medical images is tedious, time consuming, demands costly, specialty-oriented knowledge and skills, which are not easily accessible.

Accordingly, new mechanisms for reducing the burden of annotating medical images are desirable.

### SUMMARY

This objective is achieved by the subject matter of the independent claims of the present disclosure. Preferred embodiments are found in the dependent claims, in this description, and in the drawings.

The present disclosure provides a computer-implemented method of (pre-)training a machine learning model, the method comprising the steps:
receiving a plurality of unlabeled images,
generating an augmented training data set from the plurality of unlabeled images, wherein the augmented training data set comprises a first set of augmented images and a second set of augmented images, wherein the first set of augmented images is generated from the unlabeled images by applying one or more spatial augmentation techniques to the unlabeled images, wherein the second set of augmented images is generated from the images of the first set of augmented images by applying one or more masking augmentation techniques to the images of the first set of augmented images,
training a machine learning model on the first set of augmented images and the second set of augmented images, wherein the machine learning model comprises an encoder-decoder structure with a contrastive output at the end of the encoder, and a reconstruction output at the end of the decoder, wherein the machine learning model is trained:
   to output, for each image of the second set of augmented images, the respective image of the first set of augmented images via the reconstruction output, and
   to discriminate augmented images which originate from the same unlabeled image from augmented images which do not originate from the same unlabeled image via the contrastive output.

The present disclosure also provides a computer system comprising:
a processor; and
a memory storing an application program configured to perform, when executed by the processor, an operation, the operation comprising:
   receiving a plurality of unlabeled images,
   generating an augmented training data set from the plurality of unlabeled images, wherein the augmented training data set comprises a first set of augmented images and a second set of augmented images, wherein the first set of augmented images is generated from the unlabeled images by applying one or more spatial augmentation techniques to the unlabeled images, wherein the second set of augmented images is generated from the images of the first set of augmented images by applying one or more masking augmentation techniques to the images of the first set of augmented images,
   training a machine learning model on the first set of augmented images and the second set of augmented images, wherein the machine learning model comprises an encoder-decoder structure with a contrastive output at the end of the encoder, and a reconstruction output at the end of the decoder, wherein the machine learning model is trained:
      to output, for each image of the second set of augmented images, the respective image of the first set of augmented images via the reconstruction output, and
      to discriminate augmented images which originate from the same unlabeled image from augmented images which do not originate from the same unlabeled image via the contrastive output.

The present disclosure also provides a non-transitory computer readable medium storing software instructions that, when executed by a processor of a computer system, cause the computer system to:
receiving a plurality of unlabeled images,
generating an augmented training data set from the plurality of unlabeled images, wherein the augmented training data set comprises a first set of augmented images and a second set of augmented images, wherein the first set of augmented images is generated from the unlabeled images by applying one or more spatial augmentation techniques to the unlabeled images, wherein the second set of augmented images is generated from the images of the first set of augmented images by applying one or more masking augmentation techniques to the images of the first set of augmented images,
training a machine learning model on the first set of augmented images and the second set of augmented images, wherein the machine learning model comprises an encoder-decoder structure with a contrastive output at the end of the encoder, and a reconstruction output at the end of the decoder, wherein the machine learning model is trained:
   to output, for each image of the second set of augmented images, the respective image of the first set of augmented images via the reconstruction output, and
   to discriminate augmented images which originate from the same unlabeled image from augmented images which do not originate from the same unlabeled image via the contrastive output.

### BRIEF DESCRIPTION OF THE FIGURES

A better understanding of the features and advantages of the disclosed systems and methods can be obtained by reference to the detailed description of illustrative embodiments and the accompanying drawings.

FIG. 1 illustrates the generation of a first set of augmented images and a second set of augmented images from a plurality of unlabeled images, according to some embodiments.

FIG. 2 shows a schematic representation of a machine learning model, according to some embodiments.

FIG. 3(a) schematically shows the training of the machine learning model, according to some embodiments.

FIG. 3(b) schematically shows the training of the machine learning model, according to some embodiments.

FIG. 4 shows a schematic representation of a machine learning model, according to some embodiments.

FIG. 5 shows a computer system, according to some embodiments.

FIG. 6 illustrates a flow chart of an embodiment of the disclosed method.

FIG. 7 illustrates a flow chart of an embodiment of the disclosed method.

FIG. 8 illustrates a flow chart of an embodiment of the disclosed method.

### DETAILED DESCRIPTION

The invention will be more particularly elucidated below without distinguishing between the aspects of the invention (method, computer system, computer-readable storage medium). On the contrary, the following elucidations are intended to apply analogously to all the aspects of the invention, irrespective of in which context (method, computer system, computer-readable storage medium) they occur.

If steps are stated in an order in the present description or in the claims, this does not necessarily mean that the invention is restricted to the stated order. On the contrary, it is conceivable that the steps can also be executed in a different order or else in parallel to one another, unless one step builds upon another step, this absolutely requiring that the building step be executed subsequently (this being, however, clear in the individual case). The stated orders are thus preferred embodiments of the invention.

As used herein, the articles “a” and “an” are intended to include one or more items and may be used interchangeably with “one or more” and “at least one.” As used in the specification and the claims, the singular form of “a”, “an”, and “the” include plural referents, unless the context clearly dictates otherwise. Where only one item is intended, the term “one” or similar language is used. Also, as used herein, the terms “has”, “have”, “having”, or the like are intended to be open-ended terms. Further, the phrase “based on” is intended to mean “based at least partially on” unless explicitly stated otherwise. Further, the phrase “based on” may mean “in response to” and be indicative of a condition for automatically triggering a specified operation of an electronic device (e.g., a controller, a processor, a computing device, etc.) as appropriately referred to herein.

Some implementations of the present disclosure will be described more fully hereinafter with reference to the accompanying drawings, in which some, but not all implementations of the disclosure are shown. Indeed, various implementations of the disclosure may be embodied in many different forms and should not be construed as limited to the implementations set forth herein; rather, these example implementations are provided so that this disclosure will be thorough and complete, and will fully convey the scope of the disclosure to those skilled in the art.

In one aspect, the present disclosure provides means for pre-training a machine learning model with unlabeled images. The pre-trained machine learning model can then be used to further train it to perform a specific task on the basis of (a comparable small set of) labeled images. The pre-training as described herein can drastically reduce the number of labeled images required to train the machine learning model to perform the specific task. So, the term “a comparable small set of labeled images” means that fewer images are needed than if the machine learning model were trained directly.

The term “image” as used herein means a data structure that represents a spatial distribution of a physical signal. The spatial distribution may be of any dimension, for example 2D, 3D, 4D or any higher dimension. The spatial distribution may be of any shape, for example forming a grid and thereby defining pixels, the grid being possibly irregular or regular. The physical signal may be any signal, for example proton density, tissue echogenicity, tissue radiolucency, measurements related to the blood flow, information of rotating hydrogen nuclei in a magnetic field, color, level of gray, depth, surface or volume occupancy, such that the image may be a 2D or 3D RGB/grayscale/depth image, or a 3D surface/volume occupancy model. The image may be a synthetic image, such as a designed 3D modeled object, or alternatively a natural image, such as a photography or frame from a video.

In a preferred embodiment of the present disclosure, an image is a 2D or 3D medical image.

A medical image is a visual representation of the human body or a part thereof or of the body of an animal or a part thereof. Medical images can be used, e.g., for diagnostic and/or treatment purposes.

Techniques for generating medical images include X-ray radiography, computerized tomography, fluoroscopy, magnetic resonance imaging, ultrasonography, endoscopy, elastography, tactile imaging, thermography, microscopy, positron emission tomography and others.

Examples of medical images include CT (computer tomography) scans, X-ray images, MRI (magnetic resonance imaging) scans, fluorescein angiography images, OCT (optical coherence tomography) scans, histopathological images, ultrasound images and others.

A widely used format for digital medical images is the DICOM format (DICOM: Digital Imaging and Communications in Medicine).

In another preferred embodiment of the present disclosure, an image is a photograph of one or more plants or parts thereof. A photograph is an image taken by a camera (including RGB cameras, hyperspectral cameras, infrared cameras, and the like), such camera comprising a sensor for imaging an object with the help of electromagnetic radiation. The image can, e.g., show one or more plants or parts thereof (e.g., one or more leaves) infected by a certain disease (such as, for example, a fungal disease) or infested by a pest (such as, for example, a caterpillar, a nematode, a beetle, a snail or any other organism that can lead to plant damage).

In another preferred embodiment of the present disclosure, an image is an image of a part of the Earth's surface, such as an agricultural field or a forest or a pasture, taken from a satellite or an airplane (manned or unmanned aerial vehicle) or combinations thereof (remote sensing data/imagery).

“Remote sensing” means the acquisition of information about an object or phenomenon without making physical contact with the object and thus is in contrast to on-site observation. The term is applied especially to acquiring information about the Earth. Remote sensing is used in numerous fields, including geography, land surveying and most Earth science disciplines (for example, hydrology, ecology, meteorology, oceanography, glaciology, geology).

In particular, the term “remote sensing” refers to the use of satellite or aircraft-based sensor technologies to detect and classify objects on Earth. It includes the surface and the atmosphere and oceans, based on propagated signals (e.g., electromagnetic radiation). It may be split into “active” remote sensing (when a signal is emitted by a satellite or aircraft to the object and its reflection detected by the sensor) and “passive” remote sensing (when the reflection of sunlight is detected by the sensor).

Details about remote sensing data/imagery can be found in various publications (see, e.g., N. Fareed: Intelligent High Resolution Satellite/Aerial Imagery; Advances in Remote Sensing, 2014, 03. 1-9. 10.4236/ars.2014.31001; C. Yang et al.: Using High-Resolution Airborne and Satellite Imagery to Assess Crop Growth and Yield Variability for Precision Agriculture, in Proceedings of the IEEE, vol. 101, no. 3, pp. 582-592, March 2013, doi: 10.1109/JPROC.2012.2196249; P. Basnyat et al.: Agriculture field characterization using aerial photograph and satellite imagery, in IEEE Geoscience and Remote Sensing Letters, vol. 1, no. 1, pp. 7-10, Jan. 2004, doi: 10.1109/LGRS.2003.822313; WO2018/140225; WO2020/132674; WO2019/217152).

An image used as input data is usually available in a digital format. An image which is not present as a digital image file (e.g., a classic photography on color film) can be converted into a digital image file by well-known conversion tools such as an image scanner.

In a first step, a plurality of unlabeled images is received. Usually, each image of the plurality of images is a representation of the same object or category of objects.

In case of medical images, for example, each medical image of the plurality of medical images is a representation of the same part of a human body, but usually taken from different human beings or from the same human being but at different points in time. Each medical image of the plurality of images can, e.g., be a representation of an organ such as the liver, the heart, the brain, the intestine, the kidney, the lung, an eye, a part of the body such as the chest, the thorax, the stomach, the skin, or any other organ or part of the body.

In case of photos of plants or parts thereof, for example, each image of the plurality of images can be a representation of the same part of a plant (e.g., leaves and/or fruits), but usually taken from different plants or from the same plant but at different points in time.

It is also possible that each image of the plurality of images is a representation of an agricultural field or another part of the Earth's surface at a certain point in time.

Each image of the plurality of images is characterized by at least one characteristic, usually a multitude of characteristics. Some of the plurality of images share one or more characteristics whereas other images do not show the one or more characteristics. The one or more characteristics can be represented by one or more labels, such a label providing information about whether an image of the plurality of images shows one or more characteristics or does not show the one or more characteristics. Thus, a labeled image is an image for which it is known whether the image has the one or more characteristics or does not have the one or more characteristics. Accordingly, an unlabeled image is an image for which it is not known, or for which it has not (yet) been determined, whether the image has the one or more characteristics or does not have the one or more characteristics.

Returning to the example of medical images, the one or more characteristics can, e.g., be signs of a disease in the image, such as lesions, vasoconstrictions, skin changes, fractures, tumors, and/or any other symptoms which can be depicted in a medical image. Such one or more characteristics can, e.g., be signs indicative of a certain disease (see, e.g., WO2018202541A1, WO2020185758A1, WO2020229152A1, U.S. Ser. No. 10/761,075, WO2021001318, US20200134358, U.S. Ser. No. 10/713,542).

It is of course also possible to use (also) labeled images for pre-training of the machine learning model. However, the label information is not necessary for the pre-training, and the pre-training can be done without using the label information. Therefore, the term “unlabeled” should not be interpreted in a way that the invention is only applicable to unlabeled images. The invention is also applicable to labeled images, as well as to a set of images comprising labeled and unlabeled images.

Accordingly, the plurality of images received in a first step of the present disclosure may be unlabeled images for which it is not known, or for which it has not (yet) been determined, whether the images have one or more certain (specific/specified/defined) characteristics or do not have the one or more certain (specific/specified/defined) characteristics.

The term “plurality” as it is used herein means an integer greater than 1, usually greater than 10, preferably greater than 100.

The plurality of unlabeled images is used to generate an augmented training dataset.

Image augmentation is a technique that is usually used to artificially expand the size of a training dataset by creating modified versions of images in the dataset. Modification techniques used for image augmentation include geometric transformations, color space augmentations, kernel filters, mixing images, random erasing, feature space augmentation, adversarial training, generative adversarial networks, neural style transfer, meta-learning and/or the like. Augmentation operations may be performed on images and the resulting augmented images may then be stored on a non-transitory computer-readable storage medium for later training purposes. However, it is also possible to generate augmented images “in-memory” such that the augmented images may be generated temporarily and directly used for training purposes without storing the augmented images in a non-volatile storage medium.

The augmented training dataset according to the present disclosure comprises two sets of augmented images, a first set of augmented images and a second set of augmented images.

The first set of augmented images is generated by applying one or more first augmentation techniques to the unlabeled images. The second set of augmented images is generated by applying one or more second augmentation techniques to the images of the first set of augmented images.

The images of the first set of images are herein also referred to as first augmented images, and the images of the second set of images are herein also referred to as second augmented images.

Preferably, the first set of augmented images is generated by applying one or more spatial augmentation techniques to the unlabeled images. Examples of spatial augmentation techniques (also referred to as spatial modification techniques) include rigid transformations, non-rigid transformations, affine transformations and non-affine transformations.

A rigid transformation does not change the size or shape of the image. Examples of rigid transformations include reflection, rotation, and translation.

A non-rigid transformation can change the size or shape, or both size and shape, of the image. Examples of non-rigid transformations include dilation and shear.

An affine transformation is a geometric transformation that preserves lines and parallelism, but not necessarily distances and angles. Examples of affine transformations include translation, scaling, homothety, similarity, reflection, rotation, shear mapping, and compositions of them in any combination and sequence.

Preferably, the one or more spatial augmentation techniques include rotation, elastic deformation, flipping, scaling, stretching, shearing, cropping, resizing and/or combinations thereof.

In a preferred embodiment, one or more of the following first (spatial) augmentation techniques is applied to the images: rotation, elastic deformation, flipping, scaling, stretching, shearing; the first one or more first augmentation techniques preferably being followed by cropping and/or resizing.

The images resulting from spatial augmentation are also referred to as spatially augmented images.

Preferably, the second set of augmented images is generated by applying one or more masking augmentation techniques to the images of the first set of augmented images. Examples of masking augmentation techniques (also referred to as masking modification techniques) include (random and/or predefined) cutouts (e.g., inner and/or outer cutouts), and (random and/or predefined) erasing.

Augmentation techniques are described in more detail in various publications. The following list is just a small excerpt:
i. Rotation: D. Itzkovich et al.: “Using Augmentation to Improve the Robustness to Rotation of Deep Learning Segmentation in Robotic-Assisted Surgical Data,” 2019 International Conference on Robotics and Automation (ICRA), Montreal, QC, Canada, 2019, pp. 5068-5075, doi: 10.1109/ICRA.2019.8793963.
ii. Elastic deformation: E. Castro et al.: “Elastic deformations for data augmentation in breast cancer mass detection”, 2018 IEEE EMBS International Conference on Biomedical Health Informatics (BHI), pp. 230-234, 2018.
iii. Flipping: Y.-J. Cha et al.: Autonomous Structural Visual Inspection Using Region-Based Deep Learning for Detecting Multiple Damage Types, Computer-Aided Civil and Infrastructure Engineering, 00, 1-17. 10.1111/mice.12334.
iv. Scaling: S. Wang et al.: Multiple Sclerosis Identification by 14-Layer Convolutional Neural Network With Batch Normalization, Dropout, and Stochastic Pooling, Frontiers in Neuroscience, 12. 818. 10.3389/fnins.2018.00818.
v. Stretching: Z. Wang et al.: CNN Training with Twenty Samples for Crack Detection via Data Augmentation, Sensors 2020, 20, 4849.
vi. Shearing: B. Hu et al.: A Preliminary Study on Data Augmentation of Deep Learning for Image Classification, Computer Vision and Pattern Recognition; Machine Learning (cs.LG); Image and Video Processing (eess.IV), arXiv:1906.11887.
vii. Cropping and Resizing: R. Takahashi et al.: Data Augmentation using Random Image Cropping and Patching for Deep CNNs, Journal of Latex Class Files, Vol. 14, No. 8, 2015, arXiv:1811.09030.
viii. Cutout: T. DeVries and G. W. Taylor: Improved Regularization of Convolutional Neural Networks with Cutout, arXiv: 17080.04552, 2017.
ix. Erasing: Z. Zhong et al.: Random Erasing Data Augmentation, arXiv:1708.04896, 2017.

FIG. 1 illustrates the generation of a first set of augmented images Xᵢ and a second set of augmented images \tilde{X}ᵢ from a plurality of unlabeled images X.

The starting point is a plurality of images X, in this example two images, image (0-1) and image (0-2). In a first step (110) a first set of augmented images is generated from the images (0-1) and (0-2). The first set of augmented images consists of images (1-1), (1-2), (1-3), and (1-4). Images (1-1) and (1-2) are modified versions of image (0-1), whereas images (1-3) and (1-4) are modified version of image (0-2). In other words: a number N of copies is created for each of the images of the plurality of images, wherein N is an integer greater than 1 (i=1, 2, . . . , N); in this example, two copies are generated from each of the images of the plurality of images (N=2). To each copy, one or more modification techniques are applied in order to generate an augmented image. In case of the augmentation step (110) one or more spatial modification techniques are applied such as rotation, scaling, translating, cropping and/or resizing.

In a second step (120), a second set of augmented images is created from the first set of augmented images. The second set of augmented images consists of images (2-1), (2-2), (2-3), and (2-4). The second set of augmented images is generated by applying one or more modification techniques to each of the spatially augmented images (1-1), (1-2), (1-3), and (1-4). Image (2-1) is generated from image (1-1), image (2-2) is generated from image (1-2), image (2-3) is generated from image (1-3), and image (2-4) is generated from image (1-4). In case of the augmentation step (120) one or more masking modification techniques are applied such as random inner cutout, random outer cutout, and random erasing.

Image (2-1) and image (2-2) originate from the same image, i.e., image (0-1). Image (2-3) and image (2-4) result from the same image, i.e., image (0-2).

The augmented training dataset is used for pre-training of a machine learning model. The term “pre-training” refers to training a machine learning model with one task to help it form parameters that can be used in another task. In other words: the first task is to train a model to generate representations of images that then can be used in other tasks, e.g., a classification, regression, reconstruction, construction, segmentation, or other task. Examples are provided below.

Such a machine learning model, as used herein, may be understood as a computer implemented data processing architecture. The machine learning model can receive input data and provide output data based on that input data and the machine learning model, in particular the parameters of the machine learning model. The machine learning model can learn a relation between input and output data through training. In training, parameters of the machine learning model may be adjusted in order to provide a desired output for a given input.

The process of training a machine learning model involves providing a machine learning algorithm (that is the learning algorithm) with training data to learn from. The term trained machine learning model refers to the model artifact that is created by the training process. The training data must contain the correct answer, which is referred to as the target. The learning algorithm finds patterns in the training data that map input data to the target, and it outputs a machine learning model that captures these patterns.

In the training process, training data are inputted into the machine learning model and the machine learning model generates an output. The output is compared with the (known) target. Parameters of the machine learning model are modified in order to reduce the deviations between the output and the (known) target to a (defined) minimum.

In general, a loss function can be used for training to evaluate the machine learning model. For example, a loss function can include a metric of comparison of the output and the target. The loss function may be chosen in such a way that it rewards a wanted relation between output and target and/or penalizes an unwanted relation between an output and a target. Such a relation can be e.g., a similarity, or a dissimilarity, or another relation.

A loss function can be used to calculate a loss value for a given pair of output and target. The aim of the training process can be to modify (adjust) parameters of the machine learning model in order to reduce the loss value to a (defined) minimum.

A loss function may for example quantify the deviation between the output of the machine learning model for a given input and the target. If, for example, the output and the target are numbers, the loss function could be the difference between these numbers, or alternatively the absolute value of the difference. In this case, a high absolute value of the loss function can mean that a parameter of the model needs to undergo a strong change.

In the case of a scalar output, a loss function may be a difference metric such as an absolute value of a difference, a squared difference.

In the case of vector-valued outputs, for example, difference metrics between vectors such as the root mean square error, a cosine distance, a norm of the difference vector such as a Euclidean distance, a Chebyshev distance, an Lp-norm of a difference vector, a weighted norm, or any other type of difference metric of two vectors can be chosen. These two vectors may for example be the desired output (target) and the actual output.

In the case of higher dimensional outputs, such as two-dimensional, three-dimensional or higher-dimensional outputs, an element-wise difference metric (for example) may be used. Alternatively or additionally, the output data may be transformed, for example to a one-dimensional vector, before computing a loss function.

The trained machine learning model can be used to get predictions on new data for which the target is not (yet) known. The training of the machine learning model of the present disclosure is described in more detail below.

Preferably, the machine learning model in accordance with the present disclosure is or comprises an artificial neural network.

Artificial neural networks are biologically inspired computational networks. Artificial neural networks are machine learning models that employ one or more layers of nonlinear units to predict an output for a received input.

Such an artificial neural network usually comprises at least three layers of processing elements: a first layer with input neurons, an Nth layer with at least one output neuron, and N-2 inner layers, where N is a natural number greater than 2. In such a network, the input neurons serve to receive the input data. If the input data constitutes or comprises an image, there is usually one input neuron for each pixel/voxel of the input image; there can be additional input neurons for additional input data such as data about the object represented by the input image, the type of image, the way the image was acquired, and/or the like. The output neurons serve to output one or more values, e.g., a reconstructed image, a score, a regression result, and/or other values.

Some artificial neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

The processing elements of the layers are interconnected in a predetermined pattern with predetermined connection weights therebetween.

The training can be performed with a set of training data. When trained, the connection weights between the processing elements contain information regarding the relationship between the input data and the output data.

Each network node can represent a (simple) calculation of the weighted sum of inputs from prior nodes and a non-linear output function. The combined calculation of the network nodes relates the inputs to the outputs.

The network weights can be initialized with small random values or with the weights of a prior partially trained network. The training data inputs are applied to the network and the output values are calculated for each training sample. The network output values can be compared to the target output values. A backpropagation algorithm can be applied to correct the weight values in directions that reduce the error between calculated outputs and targets. The process is iterated until no further reduction in error can be made or until a predefined prediction accuracy has been reached.

A cross-validation method can be employed to split the data into training and validation data sets. The training data set is used in the error backpropagation adjustment of the network weights. The validation data set is used to verify that the trained network generalizes to make good predictions. The best network weight set can be taken as the one that presumably best predicts the outputs of the test data set. Similarly, varying the number of network hidden nodes and determining the network that performs best with the data sets optimizes the number of hidden nodes.

In a preferred embodiment, the machine learning model is or comprises a convolutional neural network (CNN). A CNN is a class of artificial neural networks, most commonly applied to e.g. analyzing visual imagery. A CNN comprises an input layer with input neurons, an output layer with at least one output neuron, as well as multiple hidden layers between the input layer and the output layer.

The hidden layers of a CNN typically comprise convolutional layers, ReLU (Rectified Linear Units) layers i.e. activation function, pooling layers, fully connected layers and normalization layers.

The nodes in the CNN input layer can be organized into a set of “filters” (feature detectors), and the output of each set of filters is propagated to nodes in successive layers of the network. The computations for a CNN include applying the mathematical convolution operation with each filter to produce the output of that filter. Convolution is a specialized kind of mathematical operation performed with two functions to produce a third function. In convolutional network terminology, the first function of the convolution can be referred to as the input, while the second function can be referred to as the convolution kernel. The output may be referred to as the feature map. For example, the input of a convolution layer can be a multidimensional array of data that defines the various color components of an input image. The convolution kernel can be a multidimensional array of parameters, where the parameters are adapted by the training process for the neural network.

The objective of the convolution operation is to extract features (such as e.g. edges from an input image) Conventionally, the first convolutional layer is responsible for capturing the low-level features such as edges, color, gradient orientation, etc. With added layers, the architecture adapts to the high-level features as well, providing a network which has the wholesome understanding of images in the dataset. Similar to the convolutional layer, the pooling layer is responsible for reducing the spatial size of the feature maps. It is useful for extracting dominant features with some degree of rotational and positional invariance, thus maintaining the process of effectively training of the model. Adding a fully-connected layer is a technique for learning non-linear combinations of the high-level features as represented by the output of the convolutional part.

The machine learning model according to the present disclosure comprises an encoder-decoder structure, also referred to as autoencoder.

An autoencoder is a type of artificial neural network used to learn efficient data encodings in an unsupervised manner. In general, the aim of an autoencoder is to learn a representation (encoding) for a set of data, typically for dimensionality reduction, by training the network to ignore “signal noise”. Along with the reduction side (encoder), a reconstructing side (decoder) is learnt, where the autoencoder tries to generate from the reduced encoding a representation as close as possible to its original input.

The U-net architecture provides a potential implementation of an encoder-decoder network (see e.g. O. Ronneberger et al.: U-net: Convolutional networks for biomedical image segmentation, arXiv:1505.04597, 2015). Skip connections may be present between the encoder and the decoder (see e.g. Z. Zhou et al.: Model Genesis, arXiv:2004.07882).

The machine learning model according to the present disclosure comprises an encoder-decoder structure, with a contrastive output at the end of the encoder, and a reconstruction output at the end of the decoder.

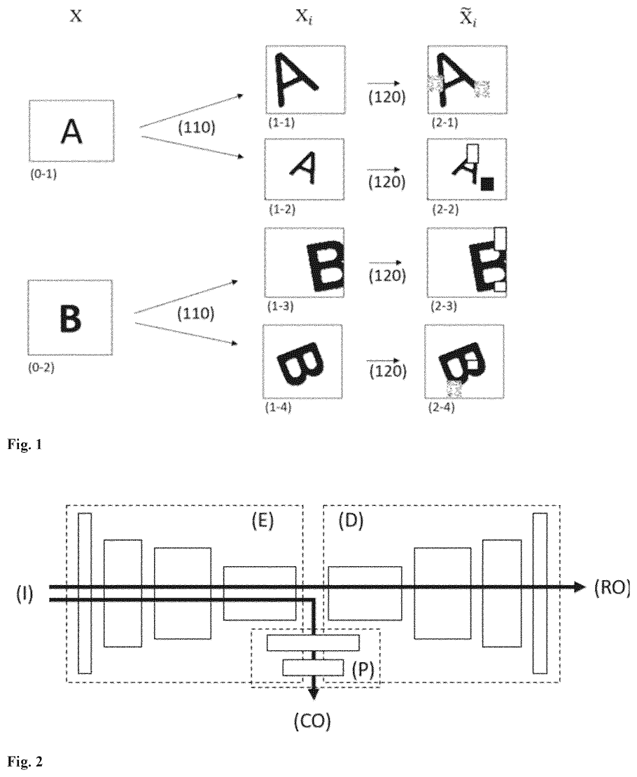

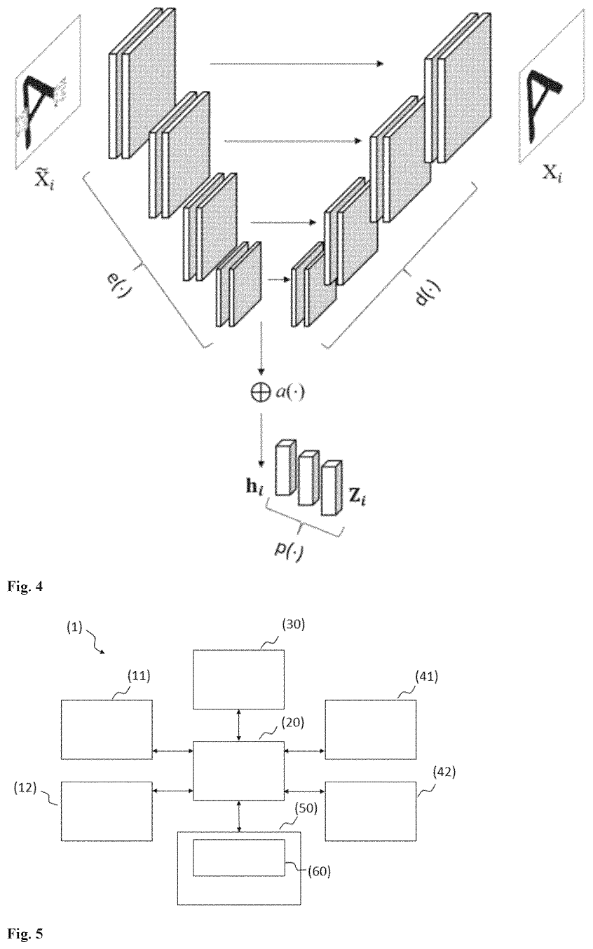

FIG. 2 is a schematic representation of a preferred embodiment of the machine learning model of the present disclosure. The machine learning model comprises a sequence of mathematical operations that can be grouped into an encoder (E) and a decoder (D). Skip connections may be present between the encoder and the decoder (as shown in FIG. 4).

The machine learning model comprises an input (I), a contrastive output (CO) at the end of the encoder, and a reconstruction output (RO) at the end of the decoder. The machine learning model further comprises a projection head (P) between the end of the encoder and the contrastive output (CO). The projection head maps the representations generated by the encoder (E) to a space where contrastive loss is applied (for more details see below).

For the pre-training of the machine learning model, the second set of augmented images is used as an input to the machine learning model.

The machine learning model is trained in an unsupervised training:
to output, for each image of the second set of augmented images (input image), the respective image of the first set of augmented images via the reconstruction output (output image), and, simultaneously,
to discriminate augmented images within the set of augmented images which originate from the same unlabeled image from augmented images which do not originate from the same unlabeled image, via the contrastive output.

In other words: the machine learning model of the present disclosure learns to generate representations of input images by performing two tasks simultaneously:
reconstructing images (reconstruction task), and
maximizing agreement between differently augmented versions of the same input image via a contrastive loss (in the latent space) (contrasting task).

The reconstruction task is performed on the basis of the second set of augmented images as input to the artificial neural network and the first set of augmented images as the output of the artificial neural network at the end of the decoder.

As already explained above, the second set of augmented images is generated from the first set of augmented images. For each image of the second set of images there is an image in the first set of images from which it has been created by having applied one or more (second) image modification techniques, preferably masking techniques such as random cutout and/or random erasing.

The aim of the reconstruction task is to generate from an image of the second set of augmented images the respective image of the first set of augmented images, which is the image within the first set of augmented images the image of the second set of augmented images is generated from.

The mean square error (MSE) between input and output images can be used as an objective function (reconstruction loss) for the image reconstruction task. Huber loss, cross-entropy and other functions can also be used as objective functions for the image reconstruction task.

Reconstructing images from modified (augmented) versions of the images is, e.g., described in Z. Zhou et al.: Model Genesis, arXiv:2004.07882. The machine learning models generated by Zhou et al. are referred to as Generic Autodidact Models. For training a Generic Autodidact Model a reconstruction task is performed by the model and a reconstruction loss is calculated. The aim of the training as disclosed by Zhou et al. is to minimize the reconstruction loss. In contrast, in case of the present disclosure, a combined reconstruction and contrasting task is performed by the machine learning model.

The contrasting task is also performed on the basis of the second set of augmented images as input to the machine learning model. For the contrasting task, a contrastive loss can be computed. Such contrastive loss can, e.g., be the normalized temperature-scaled cross entropy (NT-Xent) (see, e.g., T. Chen et al.: “A simple framework for contrastive learning of visual representations”, arXiv preprint arXiv:2002.05709, 2020, in particular equation (1)). The framework disclosed by Chen et al. is also referred to as SimCLR (Simple Framework for Contrastive Learning of Visual Representations).

Further details about contrastive learning can also be found in: P. Khosla et al.: Supervised Contrastive Learning, Computer Vision and Pattern Recognition; arXiv:2004.11362 [cs.LG]; J. Dippel, S. Vogler, J, Höhne: Towards Fine-grained Visual Representations by Combining Contrastive Learning with Image Reconstruction and Attention-weighted Pooling, arXiv:2104.04323v1 [cs.CV]).

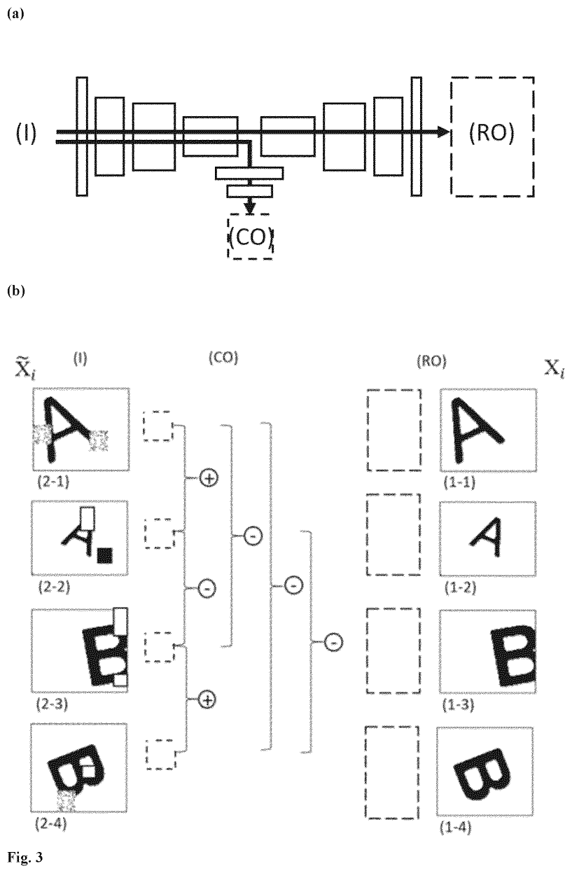

FIG. 3 (a) and FIG. 3 (b) show schematically the training of the machine learning model. In FIG. 3 (a), the machine learning model of FIG. 2 is shown in a compressed format. FIG. 3 (b) shows that the second set of augmented images \tilde{X}ᵢ of FIG. 1 is used as input (I) to the machine learning model, and that the model is trained to reconstruct the first set of augmented images Xᵢ of FIG. 1 and output the reconstructed images via the reconstruction output (RO).

In other words: via the reconstruction output (RO), the machine learning model learns to reconstruct, from an input image, the respective image which was used to generate the input image. Image (2-1) was generated from image (1-1) (see FIG. 1). So, the machine learning model learns to reconstruct image (1-1) from image (2-1). Likewise, the machine learning model learns to reconstruct image (1-2) from image (2-2), image (1-3) from image (2-3), and image (1-4) from image (2-4).

Via the contrastive output (CO), the machine learning model learns to discriminate images which originate from the same image from images which do not originate from the same image. In this example, images (2-1) and (2-2), both originate from image (0-1) (see FIG. 1), and therefore originate from the same image. The contrastive output (CO) for this pair of images is therefore an attraction, indicated by the ⊕ sign. Also, the images (2-3) and (2-4) originate from the same image, i.e., image (0-2) (see FIG. 1). Therefore, the contrastive output (CO) for this pair of images is also an attraction, indicated by the ⊕ sign. All other pairs of images inputted to the machine learning model do not originate from the same image; therefore, the contrastive output (CO) of all other pairs of images is a repulsion, indicated by the ⊖ sign.

In a preferred embodiment, a learnable nonlinear transformation is introduced between the end of the encoder and the contrastive output. Such a nonlinear transformation improves the quality of the learned representations. This can be achieved, e.g., by the introduction of a neural network projection head at the end of the encoder, the projection head mapping the representations to a space where contrastive loss is applied. The projection head can, e.g., be a multi-layer perceptron with one hidden Rectified Linear Unit (ReLU) layer.

For the combined learning of generating image reconstructions and contrasting images, a combined loss function can be generated from the reconstruction loss and the contrastive loss. The combined loss function can, e.g., be the sum or the product of the reconstruction loss and the contrastive loss. It is also possible to apply some weighing before adding or multiplying the loss functions, in order to give more weight to one loss function compared to the other one.

An example combined loss function L can be calculated as follows:

L=α·L_{c}+β·Lᵣ

where α and β are weighting factors which can be used to weight the losses, e.g., to give to a certain loss more weight than to another loss. α and β can be any value greater than zero; usually α and β represent a value greater than zero and less than or equal to one. In cases where α=β=1, each loss is given the same weight. Note, that α and β can vary during the training process. It is, for example, possible to start the training process with giving greater weight to the contrastive loss than to the reconstruction loss, and, once the deep neural network has gained a pre-defined accuracy in performing the contrastive learning task, complete the training with giving greater weight to the reconstruction task.

The reconstruction loss Lᵣ assesses the reconstruction quality. The mean square error (MSE) between input and output can be used as objective function for the proxy task of the reconstructions. Furthermore, Huber loss, cross-entropy and other functions can be used as objective function for the proxy task of reconstructions.

For the contrastive loss L_{c}, the normalized temperature-scaled cross entropy (NT-Xent) can be used (see, e.g., T. Chen et al.: “A simple framework for contrastive learning of visual representations”, arXiv preprint arXiv:2002.05709, 2020, in particular equation (1)). Further details about contrastive learning can also be found in: P. Khosla et al.: Supervised Contrastive Learning, Computer Vision and Pattern Recognition; arXiv:2004.11362 [cs.LG]; J. Dippel, S. Vogler, J, Mime: Towards Fine-grained Visual Representations by Combining Contrastive Learning with Image Reconstruction and Attention-weighted Pooling, arXiv:2104.04323v1 [cs.CV]).

FIG. 4 shows schematically an example of a machine learning model according to the present disclosure. The machine learning model as depicted in FIG. 4 is a deep neural network with one input and two outputs. The model architecture can be divided into four components: encoder e(⋅), decoder d(⋅), attention weighted pooling a(⋅) and projection head p(⋅).

For the encoder and decoder of the deep neural network, various backbones can be used such as the U-net (see, e.g., O. Ronneberger et al.: U-net: Convolutional networks for biomedical image segmentation, in: International Conference on Medical image computing and computer-assisted intervention, pp. 234-241, Springer, 2015, https://doi.org/10.1007/978-3-319-24574-4_28) or the DenseNet (e.g., G. Huang et al.: “Densely connected convolutional networks”, IEEE Conference on Computer Vision and Pattern Recognition, 2017, pp. 2261-2269, doi: 10.1109/CVPR.2017.243.).

The attention weighted pooling mechanism computes a weight for each coordinate in the activation map and then weighs them respectively before applying the global average pooling. For further details, see e.g., A. Radford et al.: Learning transferable visual models from natural language supervision, https://cdn.openai.com/papers/Learning_Transferable_Visual_Models_From_Natural_Language_Supe rvision.pdf, 2021, arXiv:2103.00020 [cs.CV]). An example is also given, e.g., in arXiv:2104.04323v1 [cs.CV].

The projection head maps the representations to a space where contrastive loss is applied. The projection head can, e.g., be a multi-layer perceptron with one hidden Rectified Linear Unit (ReLU) layer.

In the training process, the model receives a masked image \tilde{X}ᵢ and outputs the reconstructed (unmasked) image Xᵢ=d (e (\tilde{X}ᵢ)) as well as the contrastive vector representation Zᵢ=p (a(e(Xᵢ))).

The model receives an artificially masked image \tilde{X}ᵢ with the task to reconstruct Xᵢ. For each input \tilde{X}ᵢ, the model also outputs contrastive representations Zᵢ which are optimized to be (a) similar, if two inputs arise from the same original unlabeled image or (b) dissimilar if two inputs arise from distinct original unlabeled images.

The pre-trained machine learning model can be stored on a data storage and/or transmitted to another computer system, e.g., via a network.

The pre-trained machine learning models according to the present disclosure or parts thereof can be used for various purposes, some of which are described hereinafter.

Referring again to FIG. 4, once trained, the projection head p(⋅), and the decoder d(⋅) can be discarded and the remaining neural network comprising the encoder e(⋅) and the attention pooling a(⋅) can be used to generate image representations with hᵢ=a(e(X)).

The encoder of the pre-trained machine learning model can, e.g., be used as a basis for building a classifier. The encoder of the pre-trained machine learning model generates from images inputted into the encoder, latent representation vectors of the images. A classification head can be added to the end of the encoder and the resulting artificial neural network can be finally trained (fine-tuned) on a set of labeled images to classify the images according to their label.

Such a classifier can, e.g., be used for diagnostic decision support. The aim of such an approach is to identify a certain condition, such as a disease, on the basis of one or more images of a patient's body or a part thereof or a plant or a part thereof.

Very often, only a small number of labeled (annotated) images is available for training a machine learning model to identify a certain condition on the basis of images. For example, in case of a rare disease, the number of images of patients suffering from the rare disease is usually very low. Training a machine learning model to identify patients suffering from the rare disease on the basis of only a small number of images showing indications for the rare disease does not result in a useful prediction model. An example of a rare disease is chronic thromboembolic pulmonary hypertension (CTEPH). CTEPH can be diagnosed on the basis of CT scans of the patient's thorax (see, e.g., WO2018202541A1, WO2020185758A1, M. Remy-Jardin et al.: Machine Learning and Deep Neural Network Applications in the Thorax: Pulmonary Embolism, Chronic Thromboembolic Pulmonary Hypertension, Aorta, and Chronic Obstructive Pulmonary Disease, J Thorac Imaging 2020, 35 Suppl 1:S40-S48). The limited number of images from patients suffering from CTEPH can be a challenge.

The advantage of the present invention is that in a first step a first machine learning model is pre-trained on a plurality of unlabeled images. The first model learns to generate semantic-enriched representations of the images. In the second step, a second machine learning model is created from the first machine learning model by further training (fine-tuning) with a comparatively small set of available labeled (annotated) images. The second machine learning model is trained to e.g. classify patients on the basis of images.

A further use case is the development of a decision support system for pathology on the basis of whole-slide images (see, e.g., G. Campanella et al.: Clinical-grade computational pathology using weakly supervised deep learning on whole slide images, Nat Med 25, 1301-1309 (2019), https://doi.org/10.1038/x41591-019-0508-1).

A further use case is the identification of candidate signs indicative of an NTRK oncogenic fusion in a patient on the basis of histopathological images of tumor tissues (see, e.g., WO2020229152A1).

A further use case is the detection of pneumonia from chest X-rays (see, e.g., CheXNet: Radiologist-Level Pneumonia Detection on Chest X-Rays with Deep Learning; arXiv:1711.05225).

A further use case is the detection of ARDS in intensive care patients (see, e.g., WO2021110446A1).

The pre-trained machine learning model according to the present disclosure can also be used for segmentation purposes. The term segmentation, as it is used herein, refers to the process of partitioning an image into multiple segments (sets of pixels/voxels, also known as image objects). The goal of segmentation is to simplify and/or change the representation of an image into something that is more meaningful and easier to analyze. Image segmentation is typically used to locate objects and boundaries (lines, curves, etc.) in images. More precisely, image segmentation is the process of assigning a label to every pixel/voxel in an image such that pixels/voxels with the same label share certain characteristics. For the generation of a machine learning model which is capable of performing a segmentation task, the contrastive output at the end of the encoder can be removed and the resulting encoder-decoder structure can be trained on the basis of labeled images. The training set of labeled images contains images with segments and the corresponding images without segments. The machine learning model learns the segmentation of images and the finally trained machine learning model can be used to segment new images.

Segmentation of images is described in more detail in various publications and textbooks (see, e.g., L. Lu et al.: Deep Learning and Convolutional Neural Networks for Medical Image Computing: Precision Medicine, High Performance and Large-Scale Datasets, Advances in Computer Vision and Pattern Recognition, Springer, 2017, ISBN 9783319429991; WO2019/002474; WO2020/036734).

The pre-trained model can also be used to generate a synthetic image on the basis of one or more measured (real) images.

The synthetic image can, e.g., be a segmented image generated from an original (unsegmented) image (see, e.g., WO2017/091833).

The synthetic image can, e.g., be a synthetic CT images generated from an original MRI image (see, e.g., WO2018/048507A1).

The synthetic image can, e.g., be a synthetic full-contrast image generated from a zero-contrast image and a low-contrast image (see, e.g., WO2019/074938A1). In this case the input dataset comprises two images, a zero-contrast image and a low-contrast image.

It is also possible that the synthetic image is generated from one or more images in combination with further data such as data about the object which is represented by the one or more images.

The operations in accordance with the teachings herein may be performed by at least one computer system specially constructed for the desired purposes or at least one general-purpose computer system specially configured for the desired purpose by at least one computer program stored in a typically non-transitory computer readable storage medium.

The term “non-transitory” is used herein to exclude transitory, propagating signals or waves, but to otherwise include any volatile or non-volatile computer memory technology suitable to the application.

A “computer system” is a system for electronic data processing that processes data by means of programmable calculation rules. Such a system usually comprises a “computer”, that unit which comprises a processor for carrying out logical operations, and also peripherals.

In computer technology, “peripherals” refer to all devices which are connected to the computer and serve for the control of the computer and/or as input and output devices. Examples thereof are monitor (screen), printer, scanner, mouse, keyboard, drives, camera, microphone, loudspeaker, etc. Internal ports and expansion cards are, too, considered to be peripherals in computer technology.

Computer systems of today are frequently divided into desktop PCs, portable PCs, laptops, notebooks, netbooks and tablet PCs and so-called handhelds (e.g., smartphones); all these systems can be utilized for carrying out the invention.

The term “process” as used above is intended to include any type of computation or manipulation or transformation of data represented as physical, e.g., electronic, phenomena which may occur or reside, e.g., within registers and/or memories of at least one computer or processor. The term processor includes a single processing unit or a plurality of distributed or remote such units.

Any suitable input device, such as but not limited to a camera sensor, may be used to generate or otherwise provide information received by the system and methods shown and described herein. Any suitable output device or display may be used to display or output information generated by the system and methods shown and described herein. Any suitable processor/s may be employed to compute or generate information as described herein and/or to perform functionalities described herein and/or to implement any engine, interface or other system described herein. Any suitable computerized data storage, e.g., computer memory may be used to store information received by or generated by the systems shown and described herein. Functionalities shown and described herein may be divided between a server computer and a plurality of client computers. These or any other computerized components shown and described herein may communicate between themselves via a suitable computer network.

FIG. 5 illustrates a computer system (1) according to some example implementations of the present disclosure in more detail.

Generally, a computer system of exemplary implementations of the present disclosure may be referred to as a computer and may comprise, include, or be embodied in one or more fixed or portable electronic devices. The computer may include one or more of each of a number of components such as, for example, processing unit (20) connected to a memory (50) (e.g., storage device).

The processing unit (20) may be composed of one or more processors alone or in combination with one or more memories. The processing unit is generally any piece of computer hardware that is capable of processing information such as, for example, data, computer programs and/or other suitable electronic information. The processing unit is composed of a collection of electronic circuits some of which may be packaged as an integrated circuit or multiple interconnected integrated circuits (an integrated circuit at times more commonly referred to as a “chip”). The processing unit may be configured to execute computer programs, which may be stored onboard the processing unit or otherwise stored in the memory (50) of the same or another computer.

The processing unit (20) may be a number of processors, a multi-core processor or some other type of processor, depending on the particular implementation. Further, the processing unit may be implemented using a number of heterogeneous processor systems in which a main processor is present with one or more secondary processors on a single chip. As another illustrative example, the processing unit may be a symmetric multi-processor system containing multiple processors of the same type. In yet another example, the processing unit may be embodied as or otherwise include one or more ASICs, FPGAs or the like. Thus, although the processing unit may be capable of executing a computer program to perform one or more functions, the processing unit of various examples may be capable of performing one or more functions without the aid of a computer program. In either instance, the processing unit may be appropriately programmed to perform functions or operations according to example implementations of the present disclosure.

The memory (50) is generally any piece of computer hardware that is capable of storing information such as, for example, data, computer programs (e.g., computer-readable program code (60)) and/or other suitable information either on a temporary basis and/or a permanent basis. The memory may include volatile and/or non-volatile memory and may be fixed or removable. Examples of suitable memory include random access memory (RAM), read-only memory (ROM), a hard drive, a flash memory, a thumb drive, a removable computer diskette, an optical disk, a magnetic tape or some combination of the above. Optical disks may include compact disk-read only memory (CD-ROM), compact disk-read/write (CD-R/W), DVD, Blu-ray disk or the like. In various instances, the memory may be referred to as a computer-readable storage medium. The computer-readable storage medium is a non-transitory device capable of storing information and is distinguishable from computer-readable transmission media such as electronic transitory signals capable of carrying information from one location to another. Computer-readable medium as described herein may generally refer to a computer-readable storage medium or computer-readable transmission medium.

In addition to the memory (50), the processing unit (20) may also be connected to one or more interfaces for displaying, transmitting and/or receiving information. The interfaces may include one or more communications interfaces and/or one or more user interfaces. The communications interface(s) may be configured to transmit and/or receive information, such as to and/or from other computer(s), network(s), database(s) or the like. The communications interface may be configured to transmit and/or receive information by physical (wired) and/or wireless communications links. The communications interface(s) may include interface(s) (41) to connect to a network, such as using technologies such as cellular telephone, Wi-Fi, satellite, cable, digital subscriber line (DSL), fiber optics and the like. In some examples, the communications interface(s) may include one or more short-range communications interfaces (42) configured to connect devices using short-range communications technologies such as NFC, RFID, Bluetooth, Bluetooth LE, ZigBee, infrared (e.g., IrDA) or the like.

The user interfaces may include a display (30). The display may be configured to present or otherwise display information to a user, suitable examples of which include a liquid crystal display (LCD), light-emitting diode display (LED), plasma display panel (PDP) or the like. The user input interface(s) (11) may be wired or wireless and may be configured to receive information from a user into the computer system (1), such as for processing, storage and/or display. Suitable examples of user input interfaces include a microphone, image or video capture device, keyboard or keypad, joystick, touch-sensitive surface (separate from or integrated into a touchscreen) or the like. In some examples, the user interfaces may include automatic identification and data capture (AIDC) technology (12) for machine-readable information. This may include barcode, radio frequency identification (RFID), magnetic stripes, optical character recognition (OCR), integrated circuit card (ICC), and the like. The user interfaces may further include one or more interfaces for communicating with peripherals such as printers and the like.

As indicated above, program code instructions may be stored in memory, and executed by processing unit that is thereby programmed, to implement functions of the systems, subsystems, tools and their respective elements described herein. As will be appreciated, any suitable program code instructions may be loaded onto a computer or other programmable apparatus from a computer-readable storage medium to produce a particular machine, such that the particular machine becomes a means for implementing the functions specified herein. These program code instructions may also be stored in a computer-readable storage medium that can direct a computer, processing unit or other programmable apparatus to function in a particular manner to thereby generate a particular machine or particular article of manufacture. The instructions stored in the computer-readable storage medium may produce an article of manufacture, where the article of manufacture becomes a means for implementing functions described herein. The program code instructions may be retrieved from a computer-readable storage medium and loaded into a computer, processing unit or other programmable apparatus to configure the computer, processing unit or other programmable apparatus to execute operations to be performed on or by the computer, processing unit or other programmable apparatus.

Retrieval, loading and execution of the program code instructions may be performed sequentially such that one instruction is retrieved, loaded and executed at a time. In some example implementations, retrieval, loading and/or execution may be performed in parallel such that multiple instructions are retrieved, loaded, and/or executed together. Execution of the program code instructions may produce a computer-implemented process such that the instructions executed by the computer, processing circuitry or other programmable apparatus provide operations for implementing functions described herein.

Execution of instructions by processing unit, or storage of instructions in a computer-readable storage medium, supports combinations of operations for performing the specified functions. In this manner, a computer system (1) may include processing unit (20) and a computer-readable storage medium or memory (50) coupled to the processing circuitry, where the processing circuitry is configured to execute computer-readable program code (60) stored in the memory. It will also be understood that one or more functions, and combinations of functions, may be implemented by special purpose hardware-based computer systems and/or processing circuitry which perform the specified functions, or combinations of special purpose hardware and program code instructions.

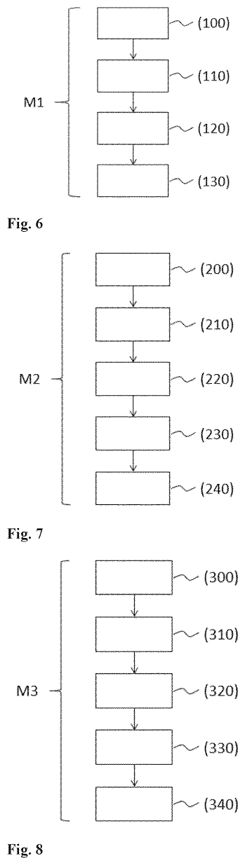

FIG. 6 shows schematically and exemplarily an embodiment of the method according to the present disclosure in the form of a flow chart. The method M1 comprises:
(100) receiving a plurality of unlabeled images,
(110) applying one or more spatial augmentation techniques to the unlabeled images, thereby generating a first set of augmented images from the plurality of unlabeled images,
(120) applying one or more masking augmentation techniques to the images of the first set of augmented images, thereby generating a second set of augmented images from the first set of augmented images,
(130) training a first machine learning model on the first set of augmented images and the second set of augmented images, wherein the first machine learning model comprises an encoder-decoder structure with a contrastive output at the end of the encoder, and a reconstruction output at the end of the decoder, wherein the first machine learning model is trained:
   to output, for each image of the second set of augmented images, the respective image of the first set of augmented images via the reconstruction output, and
   to discriminate augmented images which originate from the same unlabeled image from augmented images which do not originate from the same unlabeled image via the contrastive output.

FIG. 7 shows schematically and exemplarily another embodiment of the method according to the present disclosure in the form of a flow chart. The method M2 comprises:
(200) receiving a plurality of unlabeled images,
(210) applying one or more spatial augmentation techniques to the unlabeled images, thereby generating a first set of augmented images from the plurality of unlabeled images,
(220) applying one or more masking augmentation techniques to the images of the first set of augmented images, thereby generating a second set of augmented images from the first set of augmented images,
(230) training a first machine learning model on the first set of augmented images and the second set of augmented images, wherein the first machine learning model comprises an encoder-decoder structure with a contrastive output at the end of the encoder, and a reconstruction output at the end of the decoder, wherein the first machine learning model is trained:
   to output, for each image of the second set of augmented images, the respective image of the first set of augmented images via the reconstruction output, and
   to discriminate augmented images which originate from the same unlabeled image from augmented images which do not originate from the same unlabeled image via the contrastive output, and
(240) generating a second machine learning model from the trained first machine learning model, wherein generating the second machine learning model comprises: extracting the encoder from the encoder-decoder structure, generating a classifier from the extracted encoder, and training the classifier on a training set comprising labeled images.

FIG. 8 shows schematically and exemplarily another embodiment of the method according to the present disclosure in the form of a flow chart. The method M3 comprises:
(300) receiving a plurality of unlabeled images,
(310) applying one or more spatial augmentation techniques to the unlabeled images, thereby generating a first set of augmented images from the plurality of unlabeled images,
(320) applying one or more masking augmentation techniques to the images of the first set of augmented images, thereby generating a second set of augmented images from the first set of augmented images,
(330) training a first machine learning model on the first set of augmented images and the second set of augmented images, wherein the first machine learning model comprises an encoder-decoder structure with a contrastive output at the end of the encoder, and a reconstruction output at the end of the decoder, wherein the first machine learning model is trained:
   to output, for each image of the second set of augmented images, the respective image of the first set of augmented images via the reconstruction output, and
   to discriminate augmented images which originate from the same unlabeled image from augmented images which do not originate from the same unlabeled image via the contrastive output, and
(340) generating a second machine learning model from the trained first machine learning model, wherein generating the second machine learning model comprises: extracting the encoder-decoder structure from the trained first machine learning model, generating a segmentation network from the encoder-decoder structure, and training the segmentation network on a training set comprising labeled images.

Further preferred embodiments of the present disclosure are:
1. A computer-implemented method, the method comprising the steps:
   receiving a plurality of unlabeled images,
   generating an augmented training data set from the plurality of unlabeled images, wherein the augmented training data set comprises a first set of augmented images and a second set of augmented images, wherein the first set of augmented images is generated from the unlabeled images by applying one or more spatial augmentation techniques to the unlabeled images, wherein the second set of augmented images is generated from the images of the first set of augmented images by applying one or more masking augmentation techniques to the images of the first set of augmented images,
   training a first machine learning model on the first set of augmented images and the second set of augmented images, wherein the first machine learning model comprises an encoder-decoder structure with a contrastive output at the end of the encoder, and a reconstruction output at the end of the decoder, wherein the first machine learning model is trained:
      to output, for each image of the second set of augmented images, the respective image of the first set of augmented images via the reconstruction output, and
      to discriminate augmented images which originate from the same unlabeled image from augmented images which do not originate from the same unlabeled image via the contrastive output.
2. The method according to embodiment 1, comprising the steps:
   receiving a plurality of unlabeled images,
   generating a first set augmented images from the plurality of unlabeled images, thereby applying one or more spatial modification techniques to the unlabeled images,
   generating a second set augmented images from the first set augmented images, thereby applying one or more masking augmentation technique to the images of the first set of augmented images,
   training a first machine learning model on the first set of augmented images and the second set of augmented images, wherein the first machine learning model comprises an encoder-decoder structure with a contrastive output at the end of the encoder, and a reconstruction output at the end of the decoder, wherein the first machine learning model is trained:
      to output, for each image of the second set of augmented images, the respective image of the first set of augmented images via the reconstruction output, and
      to discriminate augmented images which originate from the same unlabeled image from augmented images which do not originate from the same unlabeled image via the contrastive output.
3. The method according to embodiment 1 or 2, wherein the unlabeled and/or labeled images are medical images.
4. The method according to any one of embodiments 1 to 3, wherein one or more of the following techniques are applied to the unlabeled images: rotation, elastic deformation, flipping, scaling, stretching, shearing, cropping, resizing and/or combinations thereof.
5. The method according to any one of embodiments 1 to 4, wherein one or more of the following techniques are applied to the images of the first set of augmented images: inner cutouts, outer cutouts, erasing and/or combinations thereof.
6. The method according to any one of embodiments 1 to 5, wherein a mean square error function, a Huber loss function of a cross-entropy loss function between input and output images is used as objective function for the proxy task of image reconstruction.
7. The method according to any one of embodiments 1 to 6, wherein a contrastive loss function is used as objective function for the discrimination task.
8. The method according to any one of embodiments 1 to 7, wherein a neural network projection head is introduced at the end of the encoder, the projection head mapping the representations to a space where contrastive loss is applied.
9. The method according to any one of embodiments 1 to 8, further comprising the steps:
   generating a second machine learning model from the first machine learning model, wherein generating the second machine learning model comprises creating a classifier on the basis of the encoder from the encoder-decoder structure, and
   training the classifier on a training set comprising labeled images.
10. The method according to any one of embodiments 1 to 8, further comprising the steps:
   generating a second machine learning model from the first machine learning model, wherein generating the second machine learning model comprises extracting the encoder-decoder structure of the trained first machine learning model from the first machine learning model, and
   training the encoder-decoder structure on the basis of labeled images to segment images.
11. A pre-trained neural network, generated by a method according to any one of embodiments 1 to 8.
12. A trained neural network, generated by the method according to embodiment 9 or 10.
13. Use of a pre-trained model according to embodiment 11 for generating a classifier by extracting the encoder from the encoder-decoder structure of the first machine learning model training and training the extracted encoder on a training set comprising labeled images.
14. Use of a trained model according to embodiment 12 for classifying and/or segmenting images, in particular medical images.
15. A computer system comprising:
   a processor; and
   a memory storing an application program configured to perform, when executed by the processor, an operation, the operation comprising:
      receiving a plurality of unlabeled images,
      generating an augmented training data set from the plurality of unlabeled images, wherein the augmented training data set comprises a first set of augmented images and a second set of augmented images, wherein the first set of augmented images is generated from the unlabeled images by applying spatial augmentation technique to the unlabeled images, wherein the second set of augmented images is generated from the images of the first set of augmented images by applying masking augmentation technique to the images of the first set of augmented images,
      training a machine learning model on the first set of augmented images and the second set of augmented images, wherein the machine learning model comprises an encoder-decoder structure with a contrastive output at the end of the encoder, and a reconstruction output at the end of the decoder, wherein the machine learning model is trained:
         to output, for each image of the second set of augmented images, the respective image of the first set of augmented images via the reconstruction output, and
         to discriminate augmented images which originate from the same unlabeled image from augmented images which do not originate from the same unlabeled image via the contrastive output.
16. A non-transitory computer readable medium having stored thereon software instructions that, when executed by a processor of a computer system, cause the computer system to execute the following steps:
   receiving a plurality of unlabeled images,
   generating an augmented training data set from the plurality of unlabeled images, wherein the augmented training data set comprises a first set of augmented images and a second set of augmented images, wherein the first set of augmented images is generated from the unlabeled images by applying spatial augmentation technique to the unlabeled images, wherein the second set of augmented images is generated from the images of the first set of augmented images by applying masking augmentation technique to the images of the first set of augmented images,
   training a machine learning model on the first set of augmented images and the second set of augmented images, wherein the machine learning model comprises an encoder-decoder structure with a contrastive output at the end of the encoder, and a reconstruction output at the end of the decoder, wherein the machine learning model is trained:
      to output for each image of the second set of augmented images the respective image of the first set of augmented images via the reconstruction output, and
      to discriminate augmented images which originate from the same unlabeled image from augmented images which do not originate from the same unlabeled image via the contrastive output.
17. A method of identifying one or more signs indicative of a disease in a medical image of a patient, the method comprising:
   providing a trained machine learning model,
   inputting the medical image into the trained machine learning model,
   receiving as an output from the trained machine learning model information indicating whether the one or more signs are present in the medical image, and
   outputting the information,
   wherein the trained machine learning model was (pre-)trained in a method according to any one of embodiments 1 to 10.
18. A method of identifying one or more signs indicative of a disease in a medical image of a patient, the method comprising:
   providing a trained machine learning model,
   inputting the medical image into the trained machine learning model,
   receiving as an output from the trained machine learning model information indicating whether the one or more signs are present in the medical image,
   outputting the information,
   wherein the trained machine learning model was pre-trained on the basis of a plurality of unlabeled images and finally trained on the basis of labeled images, wherein the pre-training comprises the following steps:
      receiving the plurality of unlabeled images,
      generating an augmented training data set from the plurality of unlabeled images, wherein the augmented training data set comprises a first set of augmented images and a second set of augmented images, wherein the first set of augmented images is generated from the unlabeled images by applying one or more spatial augmentation techniques to the unlabeled images, wherein the second set of augmented images is generated from the images of the first set of augmented images by applying one or more masking augmentation techniques to the images of the first set of augmented images,
      training a first machine learning model on the first set of augmented images and the second set of augmented images, wherein the first machine learning model comprises an encoder-decoder structure with a contrastive output at the end of the encoder, and a reconstruction output at the end of the decoder, wherein the first machine learning model is trained:
         to output for each image of the second set of augmented images the respective image of the first set of augmented images via the reconstruction output, and
         to discriminate augmented images which originate from the same unlabeled image from augmented images which do not originate from the same unlabeled image via the contrastive output,
      generating a classifier on the basis of the encoder from the encoder-decoder structure, and
      training the classifier on a training set comprising the labeled images, wherein the trained classifier constitutes the trained machine learning model.
19. A method of segmenting an image, the method comprising:
   providing a trained machine learning model,
   inputting the medical image into the trained machine learning model,
   receiving as an output from the trained machine learning model a segmented image, and
   outputting the segmented image,
   wherein the trained machine learning model was (pre-)trained in a method according to any one of embodiments 1 to 10.
20. A method of segmenting an image, the method comprising:
   providing a trained machine learning model,
inputting the medical image into the trained machine learning model,
receiving as an output from the trained machine learning model a segmented image, and
outputting the segmented image,
wherein the trained machine learning model was pre-trained on the basis of a plurality of unlabeled images and finally trained on the basis of labeled images, wherein the pre-training comprises the following steps:
   receiving the plurality of unlabeled images,
   generating an augmented training data set from the plurality of unlabeled images, wherein the augmented training data set comprises a first set of augmented images and a second set of augmented images, wherein the first set of augmented images is generated from the unlabeled images by applying one or more spatial augmentation techniques to the unlabeled images, wherein the second set of augmented images is generated from the images of the first set of augmented images by applying one or more masking augmentation techniques to the images of the first set of augmented images,
   training a first machine learning model on the first set of augmented images and the second set of augmented images, wherein the first machine learning model comprises an encoder-decoder structure with a contrastive output at the end of the encoder, and a reconstruction output at the end of the decoder, wherein the first machine learning model is trained:
      to output, for each image of the second set of augmented images, the respective image of the first set of augmented images via the reconstruction output, and
      to discriminate augmented images which originate from the same unlabeled image from augmented images which do not originate from the same unlabeled image via the contrastive output,
   extracting the encoder-decoder structure of the pre-trained machine learning model from the first machine learning model, and
   training the encoder-decoder structure on the basis of the labeled images to segment images, wherein the trained classifier constitutes the trained machine learning model.
21. A method of generating a synthetic image on the basis of one or more measured images, the method comprising:
   providing a trained machine learning model,
   inputting the one or more measured images into the trained machine learning model,
   receiving as an output from the trained machine learning model a synthetic image, and
   outputting the synthetic image,
   wherein the trained machine learning model was (pre-)trained in a method according to any one of embodiments 1 to 10.
22. A method of generating a synthetic image on the basis of one or more measured images, the method comprising:
   providing a trained machine learning model,
   inputting the one or more measured images into the trained machine learning model,
   receiving as an output from the trained machine learning model a synthetic image, and
   outputting the synthetic image,
   wherein the trained machine learning model was pre-trained on the basis of a plurality of unlabeled images and finally trained on the basis of labeled images, wherein the pre-training comprises the following steps:
      receiving the plurality of unlabeled images,
      generating an augmented training data set from the plurality of unlabeled images, wherein the augmented training data set comprises a first set of augmented images and a second set of augmented images, wherein the first set of augmented images is generated from the unlabeled images by applying one or more spatial augmentation techniques to the unlabeled images, wherein the second set of augmented images is generated from the images of the first set of augmented images by applying one or more masking augmentation techniques to the images of the first set of augmented images,
      training a first machine learning model on the first set of augmented images and the second set of augmented images, wherein the first machine learning model comprises an encoder-decoder structure with a contrastive output at the end of the encoder, and a reconstruction output at the end of the decoder, wherein the first machine learning model is trained:
         to output for each image of the second set of augmented images the respective image of the first set of augmented images via the reconstruction output, and
         to discriminate augmented images which originate from the same unlabeled image from augmented images which do not originate from the same unlabeled image via the contrastive output,
      extracting the encoder-decoder structure of the pre-trained machine learning model from the first machine learning model, and
      training the encoder-decoder structure on the basis of the labeled images to generate synthetic images, wherein the trained classifier constitutes the trained machine learning model.

### Example

Images from ModelNet (http://modelnet.cs.princeton.edu/) were used for pre-training (on the basis of unlabeled images) a first machine learning model and training (finetuning) a linear classifier generated from the first machine learning on the basis of labeled images.

The image representation model (first machine learning model) was trained on 99% of the unlabeled images. The linear classifier (second machine learning model) was trained on 1% of the embedded data with labels (3 samples for each class).

Three different approached were followed: the approach according to the present disclosure (hereinafter referred to as ConRec), the approach disclosed by Zhou et al. (arXiv:2004.07882, hereinafter referred to as Generic Autodidact Model), and the approach disclosed by Chen et al. (arXiv:2002.05709, hereinafter referred to as SimCLR). For further details, please see: arXiv:2104.04323v1 [cs.0 V].

The accuracies of the different approaches were:

| ConRec | Generic Autodidact Model | SimCLR |
|---|---|---|
| 59.84% | 56% | 53.6% |

In other words, the machine learning model of the present disclosure (ConRec) outperforms the Generic Autodidact Model as well as the SimCLR model.

1: A computer-implemented method comprising:
receiving a plurality of unlabeled images;
generating an augmented training data set from the plurality of unlabeled images, wherein the augmented training data set comprises a first set of augmented images and a second set of augmented images, wherein the first set of augmented images is generated from the unlabeled images by applying one or more spatial augmentation techniques to the unlabeled images, wherein the second set of augmented images is generated from the images of the first set of augmented images by applying one or more masking augmentation techniques to the images of the first set of augmented images;
training a first machine learning model on the first set of augmented images and the second set of augmented images, wherein the first machine learning model comprises an encoder-decoder structure with a contrastive output at the end of the encoder, and a reconstruction output at the end of the decoder, wherein the first machine learning model is trained:
to output, for each image of the second set of augmented images, the respective image of the first set of augmented images via the reconstruction output, and
to discriminate augmented images which originate from the same unlabeled image from augmented images which do not originate from the same unlabeled image via the contrastive output.

2: The method of claim 1, wherein the unlabeled images are medical images.

3: The method of claim 1, wherein the unlabeled images are photos of plants or parts thereof.

4: The method of claim 1, wherein one or more of the following techniques are applied to the unlabeled images: rotation, elastic deformation, flipping, scaling, stretching, shearing, cropping, resizing and/or combinations thereof.

5: The method of claim 1, wherein one or more of the following techniques are applied to the images of the first set of augmented images: inner cutouts, outer cutouts, erasing and/or combinations thereof.

6: The method of claim 1, wherein
training the first machine learning model comprises:
inputting a first image of the second set of augmented images into the first machine learning model;
receiving, via the reconstruction output of the first machine learning model, a first reconstructed image;
comparing the first reconstructed image with the image of the first set of augmented images from which the first image of the second set of augmented images was generated, wherein comparing comprises calculating a reconstruction loss using a reconstruction loss function, wherein the reconstruction loss is an objective function for a reconstruction task performed by the first machine learning model;
inputting a second image of the second set of augmented images into the first machine learning model;
receiving, via the contrastive output, information indicating whether the first image of the second set of augmented images and the second image of the second set of augmented images originate from the same unlabeled image or from different unlabeled images;
calculating a contrastive loss using a contrastive loss function, wherein the contrastive loss function is an objective function for a contrasting task performed by the first machine learning model;
calculating a combined loss from the reconstruction loss and the contrastive loss; and
modifying parameters of the first machine learning model to minimize the combined loss.

7: The method of claim 1, wherein a neural network projection head is introduced at the end of the encoder, wherein the projection head maps the representations to a space where contrastive loss is applied, wherein the projection head performs a learnable nonlinear transformation.

8: The method of claim 1, further comprising:
generating a second machine learning model from the first machine learning model, wherein generating the second machine learning model comprises creating a classifier based on the encoder from the encoder-decoder structure; and
training the classifier on a training set comprising labeled images.

9: The method of claim 1, further comprising:
generating a second machine learning model from the first machine learning model, wherein generating the second machine learning model comprises extracting the encoder-decoder structure from the first machine learning model; and
training the encoder-decoder structure based on labeled images to segment images.

10: The method of claim 1, comprising generating a pre-trained neural network by executing the steps of receiving the plurality of unlabeled images, generating the augmented training data set from the plurality of unlabeled images, and training the first machine learning model on the first set of augmented images and the second set of augmented images generate a pre-trained neural network.

11: The method of claim 8, comprising generating a trained neural network by executing the steps of receiving the plurality of unlabeled images, generating the augmented training data set from the plurality of unlabeled images, training the first machine learning model on the first set of augmented images and the second set of augmented images generate a pre-trained neural network, generating the second machine learning model from the first machine learning model, and training the classifier on the training set comprising labeled images.

12: The method of claim 10, comprising generating a classifier using the pre-trained neural network, wherein generating the classifier comprises extracting the encoder from the encoder-decoder structure of the first machine model training and training the extracted encoder on a set comprising labeled images.

13: The method of claim 11, comprising classifying and/or segmenting images using the trained neural network, in particular classifying and/or segmenting medical images or photos of diseased plants or pest-infected plants or parts thereof.

14: A computer system comprising:
a processor; and
a memory storing an application program configured to perform, when executed by the processor, an operation, the operation comprising:
receiving a plurality of unlabeled images;
generating an augmented training data set from the plurality of unlabeled images, wherein the augmented training data set comprises a first set of augmented images and a second set of augmented images, wherein the first set of augmented images is generated from the unlabeled images by applying one or more spatial augmentation techniques to the unlabeled images, wherein the second set of augmented images is generated from the images of the first set of augmented images by applying one or more masking augmentation techniques to the images of the first set of augmented images;
training a machine learning model on the first set of augmented images and the second set of augmented images, wherein the machine learning model comprises an encoder-decoder structure with a contrastive output at the end of the encoder, and a reconstruction output at the end of the decoder, wherein the machine learning model is trained:
to output for each image of the second set of augmented images the respective image of the first set of augmented images via the reconstruction output, and
to discriminate augmented images which originate from the same unlabeled image from augmented images which do not originate from the same unlabeled image via the contrastive output.

15: A non-transitory computer readable medium storing software instructions that, when executed by a processor of a computer system, cause the computer system to:
receive a plurality of unlabeled images,
generate an augmented training data set from the plurality of unlabeled images, wherein the augmented training data set comprises a first set of augmented images and a second set of augmented images, wherein the first set of augmented images is generated from the unlabeled images by applying one or more spatial augmentation technique to the unlabeled images, wherein the second set of augmented images is generated from the images of the first set of augmented images by applying one or more masking augmentation technique to the images of the first set of augmented images,
train a machine learning model on the first set of augmented images and the second set of augmented images, wherein the machine learning model comprises an encoder-decoder structure with a contrastive output at the end of the encoder, and a reconstruction output at the end of the decoder, wherein the machine learning model is trained;
to output, for each image of the second set of augmented images, the respective image of the first set of augmented images via the reconstruction output, and
to discriminate augmented images which originate from the same unlabeled image from augmented images which do not originate from the same unlabeled image via the contrastive output.

16: The method of claim 9, comprising generating a trained neural network by executing the steps of receiving the plurality of unlabeled images, generating the augmented training data set from the plurality of unlabeled images, training the first machine learning model on the first set of augmented images and the second set of augmented images generate a pre-trained neural network, generating the second machine learning model from the first machine learning model, and training the encoder-decoder structure based on labeled images to segment images.

17: The method of claim 16, comprising classifying and/or segmenting images using the trained neural network, in particular classifying and/or segmenting medical images or photos of diseased plants or pest-infected plants or parts thereof.
